(19) United States
(12) Patent Application Publication
(10) Pub. No.: US 2026/0003343 A1
(43) Pub. Date: Jan. 1, 2026

(54) NUMERICAL CONTROL DEVICE

(71) Applicant: Mitsubishi Electric Corporation, Tokyo (JP)

(72) Inventor: Hikari AGA, Tokyo (JP)

(73) Assignee: Mitsubishi Electric Corporation, Tokyo (JP)

(21) Appl. No.: 19/117,661

(22) PCT Filed: Mar. 14, 2023
(86) PCT No.: PCT/JP2023/009784

§ 371 Date: Apr. 2, 2025

(51) Int. Cl. G05B 19/4155; G05B 19/408

(52) U.S. Cl. CPC G05B 19/4155; G05B 19/408; G05B 2219/36084

(57) ABSTRACT

A numerical control device includes an analysis processing unit that reads a block indicated by a program counter from a numerical control program and analyzes the block and a control processing unit that generates, on the basis of an analysis result from the analysis processing unit, a command that drives a control target. When a condition wait block describing a conditional expression that indicates a condition for advancing execution of the numerical control program is read, the analysis processing unit repeatedly determines whether or not the condition is satisfied until the condition is satisfied. Until the condition is satisfied, the analysis processing unit analyzes the condition wait block before making first and subsequent determinations of whether or not the condition is satisfied.

### FIELD

The present disclosure relates to a numerical control device that controls a control target by executing a numerical control program.

### BACKGROUND

A numerical control device that executes a numerical control program to control a drive unit of a machine tool may sometimes suspend the execution of the numerical control program until a condition is satisfied. Examples of the condition include the input of an external signal, which is a signal from outside the numerical control device, and the completion of operation of another system, which is a system separate from a system including the machine tool, among others. A condition wait, which is to wait for the condition to be satisfied, is realized, for example, by a condition wait program that includes an infinite loop. The condition wait program with the infinite loop is, for example, a program that repeats specified processing until a predetermined condition is satisfied.

In the condition wait program with the infinite loop, when, for example, no blocks that involve shaft movement by the drive unit are included among blocks in the program, analysis of blocks not involving shaft movement may be repeatedly executed during a single cycle, such as a cycle in which an interrupt signal is input. In that case, the numerical control device expends a longer time on analysis processing during the single cycle, resulting in a problem of a limited time available for executing processing other than the analysis processing.

To address this problem, a numerical control device disclosed in Patent Literature 1 analyzes processing content of a condition wait block, stores an analysis result, and then performs execution processing of the condition wait block on the basis of the stored analysis result when the execution processing is to be performed.

### CITATION LIST

### Patent Literature

Patent Literature 1: Japanese Patent Application Laid-open No. 2003-108209

### SUMMARY OF INVENTION

### Problem to be Solved by the Invention

However, the above technique disclosed in Patent Literature 1 requires continued and repeated use of the analysis result obtained from the one-time analysis processing for subsequent execution processing of the condition wait block while an execution condition remains unsatisfied. Therefore, the above technique limits conditions for which the condition wait program can be used. For example, the above technique cannot handle any condition that requires computation each time, such as comparing plural external signals or comparing formula results including variable values.

The present disclosure has been made in view of the above, and an object of the present disclosure is to provide a numerical control device that reduces its analysis processing load and does not limit conditions for which a condition wait program can be used.

### Means to Solve the Problem

In order to solve the above-described problems and achieve the object, a numerical control device according to the present disclosure includes an analysis processing unit to read a block indicated by a program counter from a numerical control program and analyze the block and a control processing unit to generate a command that drives a control target on a basis of an analysis result from the analysis processing unit. When a condition wait block describing a conditional expression that indicates a condition for advancing execution of the numerical control program is read, the analysis processing unit repeatedly determines whether or not the condition is satisfied until the condition is satisfied, and until the condition is satisfied, the analysis processing unit analyzes the condition wait block before making first and subsequent determinations of whether or not the condition is satisfied.

### Effects of the Invention

The numerical control device according to the present disclosure has an effect of reducing its analysis processing load and not limiting conditions for which a condition wait program can be used.

### BRIEF DESCRIPTION OF DRAWINGS

FIG. 1 is a diagram illustrating an exemplary configuration of a machine tool that includes a numerical control device according to a first embodiment.

FIG. 2 is a flowchart illustrating a procedure of processing that is executed by an analysis processing unit of the numerical control device according to the first embodiment.

FIG. 3 is a diagram describing example processing times in a numerical control device according to a comparative example related to the first embodiment.

FIG. 4 is a diagram describing example processing times in the numerical control device according to the first embodiment.

FIG. 5 is a flowchart illustrating a procedure of processing that is executed by the analysis processing unit when a time limit is described in a condition wait block in the first embodiment.

FIG. 6 is a diagram illustrating an exemplary configuration of control circuitry according to the first embodiment.

FIG. 7 is a diagram illustrating an exemplary configuration of dedicated hardware circuitry according to the first embodiment.

### DESCRIPTION OF EMBODIMENT

With reference to the drawings, a detailed description is hereinafter provided of a numerical control device according to an embodiment.

### First Embodiment

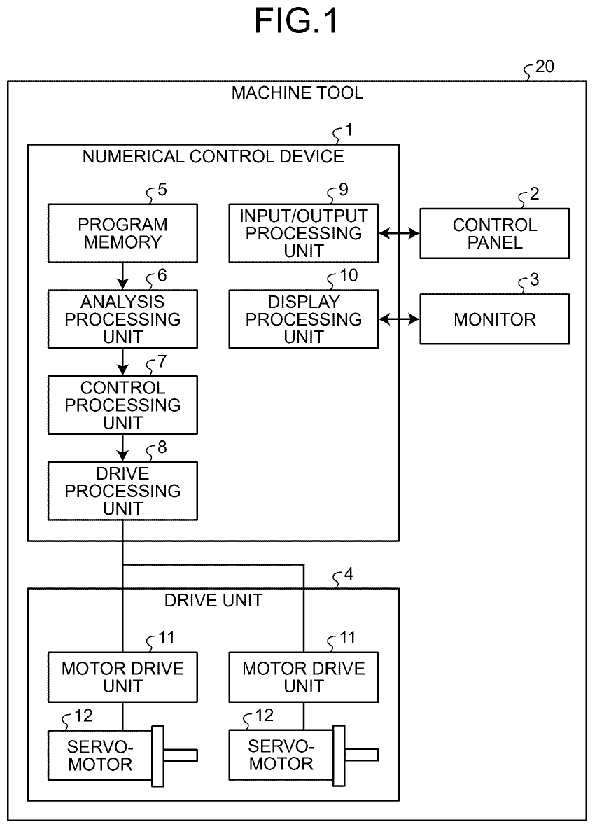

FIG. 1 is a diagram illustrating an exemplary configuration of a machine tool 20 that includes a numerical control device 1 according to a first embodiment. The machine tool 20 includes the numerical control device 1, a control panel 2, a monitor 3, and a drive unit 4. The control panel 2, the monitor 3, and the drive unit 4 are connected to the numerical control device 1. While communicating with the control panel 2 and the monitor 3, the numerical control device 1 sends commands to the drive unit 4 in accordance with descriptions in a numerical control program.

The control panel 2 includes, for example, an input device, such as a keyboard, a mouse, a keypad, or a touch panel. The control panel 2 receives operations from a user of the machine tool 20 and transmits information indicating contents of the operations to the numerical control device 1. Examples of the monitor 3 include a liquid crystal display (LCD) and an organic electroluminescence (EL) display, among others. The monitor 3 displays information processed by the numerical control device 1 on a screen.

The drive unit 4 includes motor drive units 11 and servomotors 12. The motor drive units 11 drive the servomotors 12 on the basis of the commands from the numerical control device 1. While FIG. 1 illustrates two pairs of motor drive units 11 and servomotors 12, the number of pairs of motor drive units 11 and servomotors 12 in the drive unit 4 may be any number.

The numerical control device 1 includes a program memory 5, an analysis processing unit 6, a control processing unit 7, a drive processing unit 8, an input/output processing unit 9, and a display processing unit 10. The numerical control program is stored in the program memory 5. The numerical control program is composed of plural blocks.

The analysis processing unit 6 sequentially analyzes the numerical control program block by block. The analysis processing unit 6 reads a block indicated by a program counter from the numerical control program and analyzes the block. The program counter is a register that stores an address indicating a location of a block to be executed next. The analysis processing unit 6 reads the block from the location indicated by the address stored in the program counter.

When the block read by the analysis processing unit 6 is a block that does not involve shaft movement, the analysis processing unit 6 proceeds to read and analyze a subsequent block. When the block read by the analysis processing unit 6 is a block that involves shaft movement, the analysis processing unit 6 sends an analysis result to the control processing unit 7.

The control processing unit 7 generates a command based on the analysis result from the analysis processing unit 6 to drive the drive unit 4, which is a control target. Examples of the command that the control processing unit 7 generates include target coordinates for movement through driving of the drive unit 4 and movement speed, among others. The control processing unit 7 sends the generated command to the drive processing unit 8. The drive processing unit 8 generates commands based on the command generated by the control processing unit 7 to control the servomotors 12. The drive processing unit 8 sends the generated commands to the motor drive units 11.

The input/output processing unit 9 executes processing of a case where information is input from the control panel 2 and processing of a case where information is output to the control panel 2. The display processing unit 10 executes processing of a case where information processed by the numerical control device 1 is displayed on the monitor 3. The display processing unit 10 outputs information for display to the monitor 3 and receives information input from the monitor 3. When neither the analysis processing unit 6, the control processing unit 7, nor the drive processing unit 8 executes its processing, the input/output processing unit 9 or the display processing unit 10 executes the processing.

When a condition wait block that includes a description indicating a condition for advancing execution of the numerical control program is read, the analysis processing unit 6 repeatedly determines whether or not the condition is satisfied until the condition is satisfied. The condition wait block describes the condition for advancing the execution of the numerical control program to a block that follows the condition wait block. A conditional expression is described in the condition wait block, indicating the condition for advancing the execution of the numerical control program. Until the condition is satisfied, the analysis processing unit 6 analyzes the condition wait block, which is the block describing the conditional expression, before making its first and subsequent determinations of whether or not the condition is satisfied.

For example, the analysis processing unit 6 analyzes the block describing the conditional expression before making the first determination on the condition and thereafter analyzes the block describing the conditional expression even before the subsequent determinations of the condition. In this case, the analysis processing unit 6 may analyze the block describing the conditional expression before each of the subsequent determinations of the condition or analyze the block describing the conditional expression at least once before the subsequent determinations of the condition. The analysis processing unit 6 may analyze only the block describing the conditional expression or only the conditional expression. When the condition wait block is read, the analysis processing unit 6 makes the subsequent determination without updating the program counter if the condition is not satisfied and updates the program counter if the condition is satisfied.

The conditional expression may include an operator. In that case, the analysis processing unit 6 computes the conditional expression that includes the operator. An example format of the condition wait block describing the conditional expression and an example of the condition wait block that includes the operator are shown below.
WAIT [conditional expression]
Example: WAIT [#3013 EQ 1] (Wait until #3013 becomes 1)

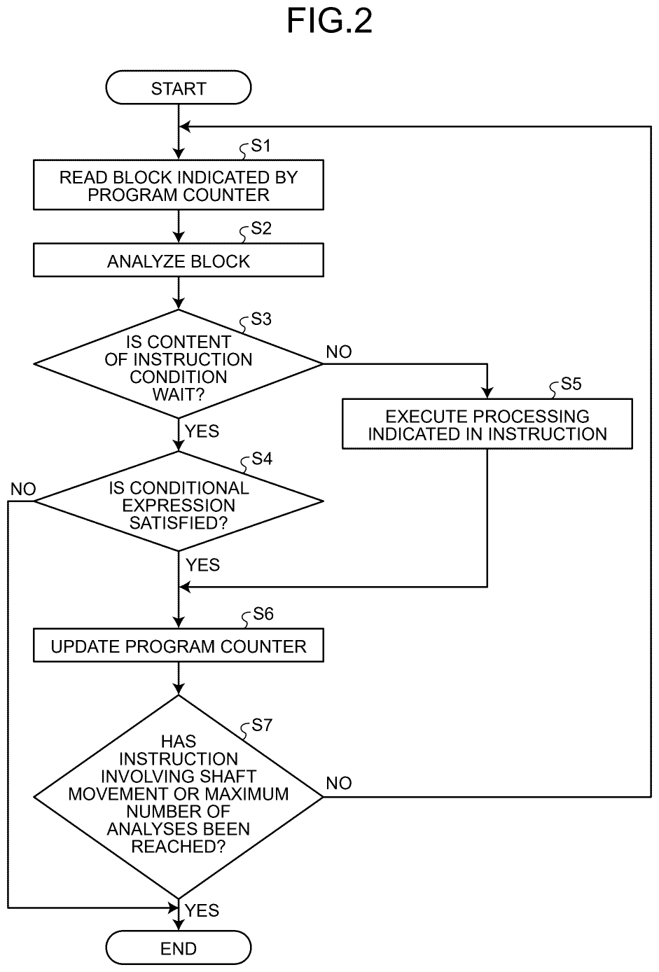

Next, a description is provided of the processing executed by the analysis processing unit 6. FIG. 2 is a flowchart illustrating a procedure of the processing executed by the analysis processing unit 6 of the numerical control device 1 according to the first embodiment.

At step S1, the analysis processing unit 6 reads a block indicated by the program counter. At step S2, the analysis processing unit 6 analyzes the block read at step S1. The analysis processing unit 6 analyzes content of an instruction indicated in the block. When a conditional expression includes an operator, the analysis processing unit 6 obtains a result of computing the conditional expression through analysis.

At step S3, the analysis processing unit 6 determines whether or not the instruction content analyzed at step S2 is a condition wait. In other words, the analysis processing unit 6 determines whether or not the block read at step S1 is a condition wait block. The condition wait block here is assumed to be a WAIT block as shown in the format above. When the read block is the WAIT block, the analysis processing unit 6 determines that the read block is the condition wait block. If the instruction content is a condition wait (step S3, Yes), the analysis processing unit 6 proceeds to step S4 in the procedure. On the other hand, if the instruction content is not a condition wait (step S3, No), the analysis processing unit 6 proceeds to step S5 in the procedure.

At step S4, the analysis processing unit 6 determines whether or not the conditional expression is satisfied. In other words, the analysis processing unit 6 makes a determination on the condition. If the conditional expression is satisfied (step S4, Yes), the analysis processing unit 6 proceeds to step S6 in the procedure. On the other hand, if the conditional expression is not satisfied (step S4, No), the analysis processing unit 6 ends the processing according to the procedure illustrated in FIG. 2. When the conditional expression is not satisfied, the analysis processing unit 6 ends the analysis processing without updating the program counter and reanalyzes the conditional expression in subsequent analysis processing.

At step S5, the analysis processing unit 6 executes processing indicated in the instruction for the block determined as not being a condition wait block. After completing step S5, the analysis processing unit 6 proceeds to step S6 in the procedure.

At step S6, the analysis processing unit 6 updates the program counter to a block to be executed next. Next, at step S7, the analysis processing unit 6 determines whether or not an instruction involving shaft movement has been reached or whether or not a maximum number of analyses has been reached. The maximum number of analyses is preset.

If an instruction involving shaft movement has not been reached, and the maximum number of analyses has not been reached (step S7, No), the analysis processing unit 6 returns to step S1 in the procedure. The analysis processing unit 6 reads and analyzes the next block. On the other hand, if an instruction involving shaft movement has been reached, or the maximum number of analyses has been reached (step S7, Yes), the analysis processing unit 6 ends the processing according to the procedure illustrated in FIG. 2.

If the analysis processing is executed plural times until the condition is satisfied, limited time available for processing other than the analysis processing would make it difficult for the numerical control device 1 to ensure, for example, real-time update of the screen display. Alternatively, ensuring real-time communication with the external devices would be difficult.

According to the first embodiment, the analysis processing unit 6 ends the analysis processing without updating the program counter when the condition is not satisfied. Since the analysis processing unit 6 analyzes only one block in the single analysis processing, the numerical control device 1 can reduce its analysis processing load compared to when plural blocks need to be analyzed in the single analysis processing. By reducing the analysis processing load, the numerical control device 1 can avoid a situation where the numerical control device 1 expends most of its processing capacity on the analysis processing. Thus, the numerical control device 1 can ensure sufficient processing capacity for processing other than the analysis processing.

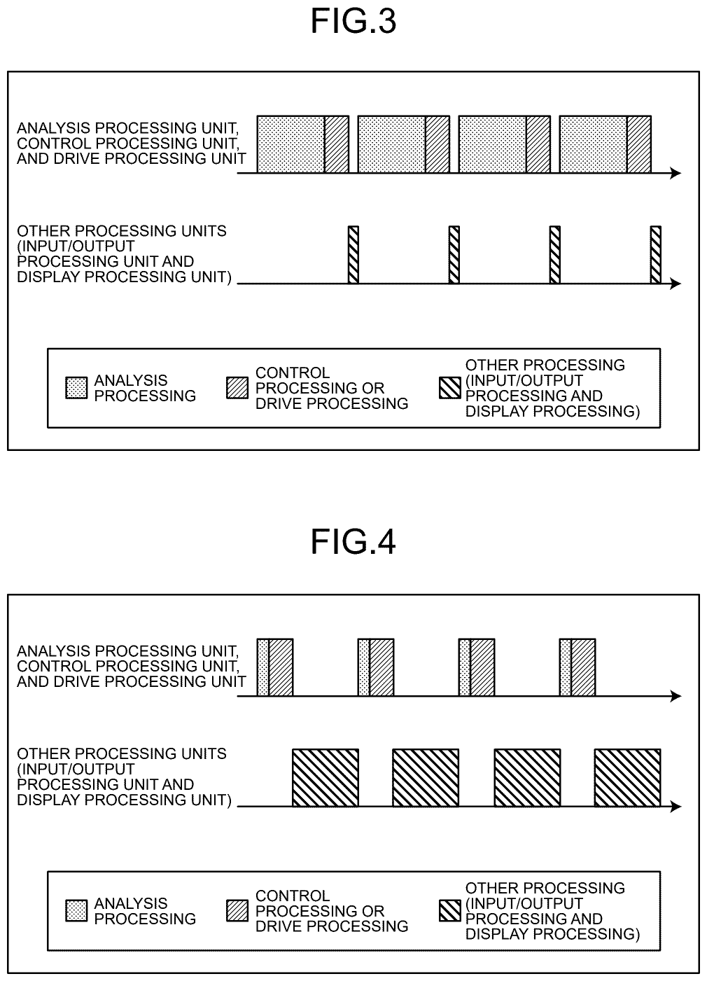

FIG. 3 is a diagram describing example processing times in a numerical control device according to a comparative example related to the first embodiment. FIG. 4 is a diagram describing example processing times in the numerical control device 1 according to the first embodiment. In FIGS. 3 and 4, a horizontal axis represents time. In FIGS. 3 and 4, each length of time during which the processing is executed is represented by a hatched rectangle. In FIGS. 3 and 4, the analysis processing, the control or drive processing, and the other processing are performed in a single cycle. The term “single cycle” refers to, for example, a cycle during which an interrupt signal is input.

FIG. 4 illustrates the examples of the duration of the analysis processing, the duration of the control or drive processing, and the duration of the other processing in the first embodiment. The analysis processing is the processing executed by the analysis processing unit 6. The control processing is the processing executed by the control processing unit 7. The drive processing is the processing executed by the drive processing unit 8. The other processing refers to any processing executed by the numerical control device 1, excluding the analysis processing, the control processing, and the drive processing. The other processing includes the input/output processing, which is the processing executed by the input/output processing unit 9, and the display processing, which is the processing executed by the display processing unit 10.

FIG. 3 illustrates an example where all blocks, from an infinite-loop WHILE block to an END block, are analyzed in a single analysis processing. FIG. 3 illustrates the examples of the duration of the analysis processing, the duration of the control or drive processing, and the duration of the other processing.

In the comparative example illustrated in FIG. 3, the analysis processing occupies most of the numerical control device's processing time. Therefore, the processing time during which the other processing is executed is significantly shorter than the processing time during which the analysis processing is executed. On the other hand, the first embodiment illustrated in FIG. 4 significantly reduces the processing time during which the analysis processing is executed compared to the comparative example illustrated in FIG. 3. Therefore, the first embodiment illustrated in FIG. 4 allows for an increase in the processing time during which the other processing is executed, compared to the comparative example illustrated in FIG. 3.

As described above, the numerical control device 1 according to the first embodiment can reduce the analysis processing load, thereby ensuring sufficient processing capacity for the other processing. By securing the processing capacity, the numerical control device 1 can ensure real-time performance of the other processing. For example, the numerical control device 1 can ensure real-time performance in updating the screen display or communicating with the external devices.

According to the first embodiment, when the condition wait block is read, the analysis processing unit 6 analyzes the content of the instruction indicated in the condition wait block before making the determination on the condition, such as determining whether or not to continue an infinite loop. Since the analysis processing unit 6 analyzes the conditional expression described in the condition wait block before making the determination on the condition, the analysis processing unit 6 can make a determination on a condition that requires computation each time. Therefore, the numerical control device 1 can implement condition waits for various conditions. Furthermore, since only the block describing the conditional expression or only the conditional expression is analyzed before the determination of the condition, there is a reduced number of blocks described in a condition wait program. The reduction in the number of blocks allows for improved readability and maintainability of the numerical control program.

The condition wait block may include a description of a time limit for waiting until the condition is satisfied. As shown below, a time limit argument may be added to the condition wait block.
WAIT [conditional expression, time limit]

When the time limit is described, the analysis processing unit 6 terminates waiting for the condition to be satisfied if the time limit elapses after the waiting for the condition to be satisfied has started.

When the condition is not satisfied within the time limit, the numerical control device 1 may notify a unit external to the numerical control device 1 that the condition is not satisfied. Alternatively, the numerical control device 1 may instruct the drive unit 4 to perform axial movement toward a safe position when the condition is not satisfied within the time limit. The analysis processing unit 6 may execute a prespecified program to enable such an operation when the condition is not satisfied within the time limit. The user can specify a program of choice as the program to be executed when the condition is not satisfied within the time limit. This allows the user to cause the numerical control device 1 to perform an operation of choice when the condition is not satisfied within the time limit.

Alternatively, the analysis processing unit 6 may execute a prespecified program when the condition is satisfied. The user can specify a program of choice as the program to be executed when the condition is satisfied. This allows the user to cause the numerical control device 1 to perform an operation of choice when the condition is satisfied. Thus, the analysis processing unit 6 may perform the execution of the prespecified program at least one of a case where the condition is satisfied or a case where the condition is not satisfied within the time limit.

An example format of the condition wait block that describes the time limit and an example of the condition wait block describing the time limit are shown below. The example below includes an instruction for when the conditional expression is satisfied and an instruction for when the time limit elapses. The instruction for when the conditional expression is satisfied represents the prespecified program that is to be executed when the condition is satisfied. The instruction for when the time limit elapses represents the prespecified program that is to be executed when the condition is not satisfied within the time limit.
WAITIF [conditional expression, time limit]
THEN Instruction for when conditional expression is satisfied
ELSE Instruction for when time limit elapses

### Example: WAITIF [[#1031EQ1] AND [#1032EQ1], 1000]

THEN GOTO210
ELSE GOTO999
N210
:
N999

(Wait up to 1000 seconds for #1031 and #1032 to become 1, jump to block N210 when the condition is satisfied, and jump to block N999 when the time limit elapses.)

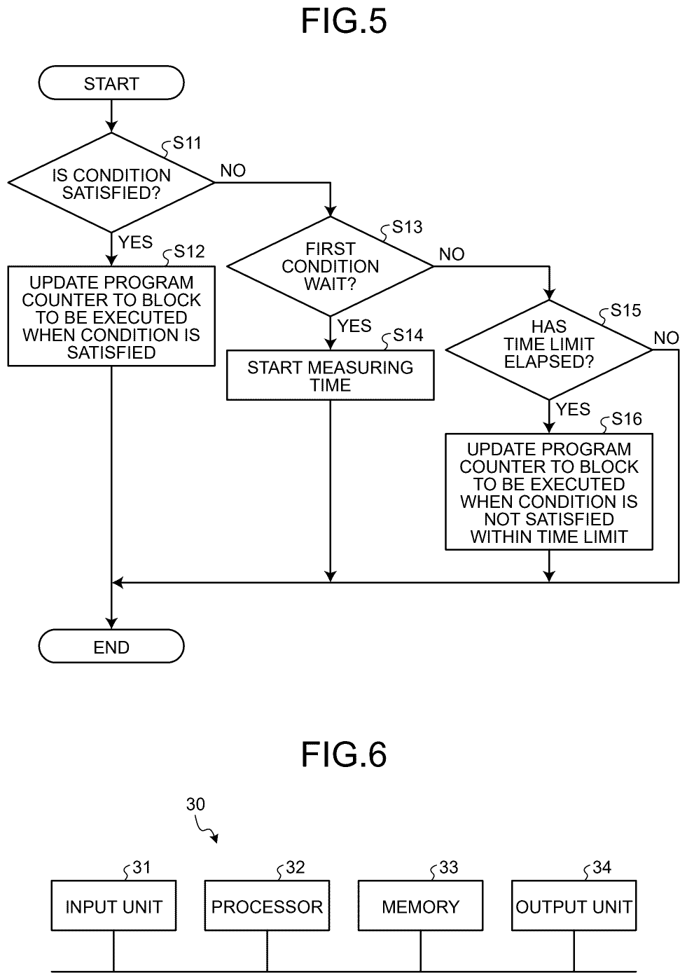

Next, a description is provided of processing that the analysis processing unit 6 executes when the time limit is described in the condition wait block. FIG. 5 is a flowchart illustrating a procedure of the processing that is executed by the analysis processing unit 6 when the time limit is described in the condition wait block in the first embodiment. FIG. 5 illustrates example steps that are added to the procedure illustrated in FIG. 2 when a time limit is described in a condition wait block. Herein, both a program to be executed when the condition is satisfied and a program to be executed when the condition is not satisfied within the time limit are specified.

At step S11, the analysis processing unit 6 determines whether or not the condition is satisfied. Step S11 corresponds to step S4 in FIG. 2. If the condition is satisfied (step S11, Yes), the analysis processing unit 6 updates the program counter at step S12 to a block to be executed when the condition is satisfied. After completing step S12, the analysis processing unit 6 ends the processing according to the procedure illustrated in FIG. 5. The block to be executed when the condition is satisfied is the above-mentioned THEN block. After executing the THEN block, the analysis processing unit 6 executes a block that follows the THEN block.

On the other hand, if the condition is not satisfied (step S11, No), the analysis processing unit 6 determines at step S13 whether or not the current condition wait is the first condition wait after the condition wait block has been read. If the current condition wait is the first condition wait (step S13, Yes), the analysis processing unit 6 starts measuring time at step S14. After completing step S14, the analysis processing unit 6 ends the processing according to the procedure illustrated in FIG. 5. The analysis processing unit 6 continuously measures time while repeating the block analysis and the determination of the condition.

On the other hand, if the current condition wait is not the first condition wait (step S13, No), the analysis processing unit 6 determines at step S15 whether or not the time limit has elapsed after starting the time measurement. If the time limit has elapsed after the start of the time measurement (step S15, Yes), the analysis processing unit 6 updates the program counter at step S16 to a block to be executed when the condition is not satisfied within the time limit. The block to be executed when the condition is not satisfied within the time limit is the above-mentioned ELSE block.

On the other hand, if the time limit has not elapsed after the start of the time measurement (step S15, No), the analysis processing unit 6 ends the processing according to the procedure illustrated in FIG. 5. The analysis processing unit 6 continuously measures time while repeating the block analysis and the determination of the condition.

The instruction for when the conditional expression is satisfied and the instruction for when the time limit elapses may be written on the same line as the condition wait block, as shown below. In that case, more blocks can be displayed at a time when the numerical control program is displayed on the screen.
WAITIF [conditional expression, time limit] THEN Instruction for when conditional expression is satisfied ELSE Instruction for when time limit elapses

Instructions for when the conditional expression is satisfied and instructions for when the time limit elapses may be written in plural blocks, as shown below. In other words, the analysis processing unit 6 may execute a condition wait block that includes at least one of the plurality of blocks to be executed when the condition is satisfied or the plurality of blocks to be executed when the condition is not satisfied within the time limit. In that case, the analysis processing unit 6 can execute a condition wait program that can handle a wider range of usages.
WAITIF [conditional expression, time limit] THEN
Instruction 1 for when conditional expression is satisfied
:
Instruction n for when conditional expression is satisfied
ELSE
Instruction 1 for when time limit elapses
:
Instruction m for when time limit elapses
ENDIF

According to the first embodiment, when the condition wait block is read, the analysis processing unit 6 repeatedly determines whether or not the condition is satisfied until the condition is satisfied. Until the condition is satisfied, the analysis processing unit 6 analyzes only the block describing the conditional expression or only the conditional expression before making its determination on the condition. The numerical control device 1 can reduce its analysis processing load compared to when plural blocks need to be analyzed in the single analysis processing. Furthermore, the numerical control device 1 can make the determination on the condition that requires computation, eliminating the need to limit conditions for which the condition wait program can be used. In other words, the numerical control device 1 can implement condition waits for various conditions. As described above, the numerical control device 1 has an effect of reducing its analysis processing load and not limiting the conditions for which the condition wait program can be used.

Next, a description is provided of hardware that implements the numerical control device 1 according to the first embodiment. The analysis processing unit 6, the control processing unit 7, the drive processing unit 8, the input/output processing unit 9, and the display processing unit 10, which are the processing units of the numerical control device 1, are implemented by processing circuitry. The processing circuitry may be circuitry where a processor executes software or dedicated circuitry.

When the processing circuitry is implemented using software, the processing circuitry is, for example, control circuitry illustrated in FIG. 6. FIG. 6 is a diagram illustrating an exemplary configuration of the control circuitry 30 according to the first embodiment. The control circuitry 30 includes an input unit 31, a processor 32, a memory 33, and an output unit 34. The input unit 31 is an interface circuit that receives data input from outside the control circuitry 30 and provides the data to the processor 32. Information from each of the control panel 2 and the monitor 3 is input to the input unit 31. The output unit 34 is an interface circuit that sends data from the processor 32 or the memory 33 to the outside of the control circuitry 30. The output unit 34 outputs information to each of the control panel 2 and the monitor 3.

When the processing circuitry is the control circuitry 30 illustrated in FIG. 6, the processing units of the numerical control device 1 are implemented using the software, firmware, or a combination of software and firmware. The software or the firmware is described as programs and is stored in the memory 33. In the processing circuitry, the processor 32 reads and executes the programs stored in the memory 33 to implement the functions. This means that the memory 33 is included in the processing circuitry to store the programs that result in the execution of the operations of the numerical control device 1. These programs can be said to cause a computer to execute the steps and the methods of the numerical control device 1. The above-mentioned program counter is included in the processor 32.

The processor 32 is a central processing unit (CPU), a processing unit, an arithmetic unit, a microprocessor, a microcomputer, a processor, or a digital signal processor (DSP). Examples that each correspond to the memory 33 include nonvolatile and volatile semiconductor memories, such as a random-access memory (RAM), a read-only memory (ROM), a flash memory, an erasable programmable read-only memory (EPROM), and an electrically erasable programmable read-only memory (EEPROM) (registered trademark), a magnetic disk, a flexible disk, an optical disk, a compact disk, a mini disk, and a digital versatile disc (DVD), among others. The program memory 5 is implemented by the memory 33.

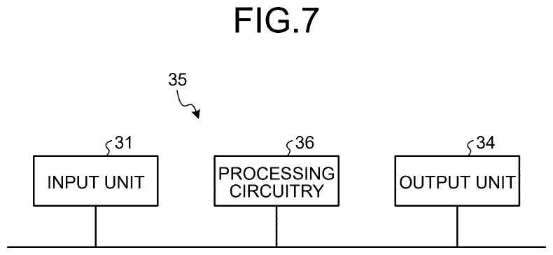

While FIG. 6 illustrates the example of hardware in which the general-purpose processor 32 and the memory 33 are used to implement the constituent elements, the constituent elements may be implemented by dedicated hardware circuitry. FIG. 7 is a diagram illustrating an exemplary configuration of the dedicated hardware circuitry 35 according to the first embodiment.

The dedicated hardware circuitry 35 includes the input unit 31, the output unit 34, and processing circuitry 36. The processing circuitry 36 is a single circuit, a composite circuit, a programmed processor, a parallel programmed processor, an application-specific integrated circuit (ASIC), a field-programmable gate array (FPGA), or a combination of these. The functions of the numerical control device 1 may be implemented individually or collectively by the processing circuitry 36. The constituent elements may be implemented by combining the control circuitry 30 with the hardware circuitry 35.

The above configurations illustrated in the embodiment are illustrative of contents of the present disclosure. The configurations of the embodiment can be combined with other techniques that are publicly known. The configurations of the embodiment can be partly omitted or changed without departing from the gist of the present disclosure.

### REFERENCE SIGNS LIST

1 numerical control device; 2 control panel; 3 monitor; 4 drive unit; 5 program memory; 6 analysis processing unit; 7 control processing unit; 8 drive processing unit; 9 input/output processing unit; 10 display processing unit; 11 motor drive unit; 12 servomotor; 20 machine tool; 30 control circuitry; 31 input unit; 32 processor; 33 memory; 34 output unit; 35 hardware circuitry; 36 processing circuitry.

1. A numerical control device comprising:
analysis processing circuitry to read a block indicated by a program counter from a numerical control program and analyze the block; and
control processing circuitry to generate a command that drives a control target on a basis of an analysis result from the analysis processing circuitry, wherein
when a condition wait block describing a conditional expression that indicates a condition for advancing execution of the numerical control program is read, the analysis processing circuitry repeatedly determines whether or not the condition is satisfied until the condition is satisfied, and until the condition is satisfied, the analysis processing circuitry analyzes the condition wait block before making first and subsequent determinations of whether or not the condition is satisfied,
the analysis processing circuitry analyzes only one block that is the condition wait block in a single analysis processing, and
the analysis processing circuitry computes the conditional expression that includes an operator.

2. (canceled)

3. The numerical control device according to claim 1, wherein
the condition wait block includes a description of a time limit for waiting until the condition is satisfied, and
the analysis processing circuitry terminates waiting for the condition to be satisfied when the time limit elapses after the waiting for the condition to be satisfied has started.

4. The numerical control device according to claim 3, wherein the analysis processing circuitry performs execution of a prespecified program at least one of a case where the condition is satisfied or a case where the condition is not satisfied within the time limit.

5. The numerical control device according to claim 4, wherein the analysis processing circuitry executes the condition wait block that includes at least one of a plurality of blocks to be executed when the condition is satisfied or a plurality of blocks to be executed when the condition is not satisfied within the time limit.
